(19) United States
(12) Patent Application Publication
(10) Pub. No.: US 2026/0184023 A1
(43) Pub. Date: Jul. 2, 2026

(54) WORKPIECE MADE OF TWO COMPONENTS JOINED TOGETHER BY MEANS OF AN ADHESIVE, JOINING METHOD, AND ACTUATOR COMPRISING SUCH A WORKPIECE

(71) Applicant: Schaeffler Technologies AG & Co. KG, Herzogenaurach (DE)

(72) Inventors: Pascal Verbücheln, Bühl (DE); Jean-Georges Friedmann, Hatten (FR); Marc Beyer, Haguenau (FR)

(73) Assignee: Schaeffler Technologies AG & Co. KG, Herzogenaurach (DE)

(21) Appl. No.: 19/127,424

(22) PCT Filed: Oct. 9, 2023
(86) PCT No.: PCT/DE2023/100747

§ 371 Date: May 6, 2025

(30) Foreign Application Priority Data
Nov. 7, 2022 (DE) 10 2022 129 287.8

(51) Int. Cl. B29C 65/52; B29C 65/00

(52) U.S. Cl. CPC B29C 65/52; B29C 66/5221; B29C 66/7422

(57) ABSTRACT

The invention relates to a workpiece made of two components joined together by means of an adhesive. A first component has a reservoir for receiving the adhesive in a first state, and one of the components undergoes a geometric change in a second state during the joining process such that the reservoir is reduced in size and adhesive is moved out of the reservoir.

### CROSS-REFERENCE TO RELATED APPLICATIONS

This application is the U.S. National Phase of PCT Application No. PCT/DE2023/100747 filed on Oct. 9, 2023, which claims priority to DE 10 2022 129 287.8 filed on Nov. 7, 2022, the entire disclosures of which are incorporated by reference herein.

### TECHNICAL FIELD

The present disclosure relates to a workpiece made of two components joined together by means of an adhesive. Furthermore, the disclosure also relates to a joining method for joining a first component and a second component in order to form a generic workpiece, and an actuator for use in a motor vehicle comprising a generic workpiece.

### BACKGROUND

Workpieces that are joined together from at least two components are already known from the prior art. WO 2008/116442 A2 shall be mentioned here as an example. A bearing is presented therein in which an adhesive connection is made between the inner ring or outer ring and a shaft or housing by means of an adhesive on the inner ring or outer ring. The adhesive here has a protective layer that is destroyed during the joining process such that the adhesive connection can then be made during the joining process. This requires a special adhesive that must be prepared accordingly and the protective layer of which must always remain intact.

The present disclosure is based on manufacturing a workpiece from two components in such a way that a connection using a conventional adhesive can also be achieved and in which the joining method can be carried out more easily with regard to the adhesive used.

The object of the disclosure is achieved by a generic workpiece assembly described herein.

The workpiece assembly can be a plug-in module, for example. It can also be part of an actuator in which a ring-shaped element, as the second component, is pushed onto a sleeve as the first component. In particular, the two components can also be made of different materials, such as plastic and aluminum.

According to the disclosure, one of the components undergoes a geometric change in a second state during a joining method such that the reservoir is reduced in size or volume and adhesive is moved out of the reservoir. It is then no longer necessary to apply the adhesive to the location where the adhesive connection is to be made later prior to the joining method. Accordingly, the adhesive does therefore not need to be protected from any adverse effects on it. In a first state, at least prior to the two components being finally joined together, the first component has the corresponding reservoir for receiving the adhesive. The geometric dimensions of the reservoir are designed such that sufficient adhesive can be received and transferred from the reservoir to the intended positions for creating the adhesive connection during the execution of the joining method.

For this purpose, the reservoir can be designed in the form of a circumferential groove, for example. During the execution of the joining method, the reservoir is reduced in size such that its volume and capacity to receive adhesive is reduced. The adhesive is moved out of the reservoir into the region radially between the first and second components, which is used for the intended adhesive connection.

In a further development, one of the two components comprises a partial piece which in the first state is connected to the main part of the one component via a predetermined breaking point and which partial piece in the second state is at least partially displaced into the space of the reservoir with the breaking the predetermined breaking point in such a way that the reservoir is reduced in size. In an example embodiment, the reservoir is provided in or on the first component. In particular, it can be at least partially defined or formed by the partial piece itself. The partial piece can, for example, constitute an axial boundary of the reservoir. By breaking the predetermined breaking point, the partial piece is then moved into the reservoir in the following joining method and presses the adhesive in the axial direction, i.e., in the joining direction from the reservoir to the desired locations between the first and second component.

In example embodiment, the second component has a hollow-cylindrical region, this hollow-cylindrical region is radially enclosed by an inner wall and this inner wall at least partially radially encloses the first component in the second state. In other words, the second component is at least partially hollow on the inside and can be pushed over at least one region of the second component in such a way that both regions are nested in one another after completion of the joining method. The adhesive from the reservoir is then advantageously applied between the two components in this second state and ensures an adhesive connection between the nested regions.

For better distribution of the adhesive and a simple implementation of the reservoir, the first component can be divided by the predetermined breaking point into an axially frontal region formed by the partial piece and an axially rearward region formed by the main part, and the second component can have an axial stop which, in the second state, strikes axially against the partial piece during the joining method and displaces it axially, in particular in the joining direction, with the breaking of the predetermined breaking point into the reservoir. In particular, the axial stop can be the bottom of the second component. In particular, the second component can be designed as an essentially pot-shaped component for this purpose.

In order to ensure that adhesive is distributed exclusively in the joining direction, i.e., in the direction of the axial displacement of the second component, and that targeted bonding of the two components only takes place in this region, the partial piece of the first component can have an outer wall which lies radially outside of an outer wall of the main part and the adhesive lies radially inside of the outer wall in the first state. When the two components are pushed together, the outer component, i.e., the second component, is always radially outside of the partial piece or the outer wall of the partial piece. This means that after joining, there is a gap between the outer wall of the main part and the inner wall of the second component, which corresponds to the height difference between the two outer walls of the partial piece and the main part. This gap then serves to receive the adhesive, which is pressed out of the reservoir as the partial piece penetrates and ensures that the two components are bonded together.

In this regard, the reservoir is formed in particular by the partial piece and the main part itself. The main part has a shoulder that divides the radial outer side of the main part in the axial direction into a radially lower region and a radially higher region. The radially lower region is bounded axially by the partial piece on the one hand and by the shoulder of the main part on the other. The predetermined breaking point is located directly in this region between the partial piece and the radially lower region.

In an example embodiment, the first and second components are each hollow cylinders which are pushed into one another in a second state. In this way, no wedging due to corners is to be expected. This is the easiest way to align the components to one another.

According to method for joining the first component and the second component in order to form a workpiece, in a first step, adhesive is filled into the reservoir of the first component. In this regard, the reservoir can be designed as described above. The filling does not have to meet any special requirements.

In a second step, the second component is pushed onto the first component until, in a second state of the workpiece, an axial stop of the second component strikes against a partial piece of the first component. As described above, the axial stop can be a bottom of the second component, wherein the second component can be designed as pot-shaped. Alternatively, it can also be a projection extending radially inwards from the inner edge of the second component, which extends around the inner circumference of the second component and strikes against the partial piece.

In a third step, the partial piece is broken off from the main part of the first component at a predetermined breaking point and pushed through the stop into the reservoir in the joining direction.

In a fourth step, adhesive can then be pressed through the partial piece out of the reservoir and into a radially lower region of the main part lying axially behind the reservoir in the joining direction. For this purpose, the outer wall of the partial piece can be located radially higher than the outer wall of the main part. A gap is thus formed between the first and second components, which can receive the adhesive.

In a fifth step, the second component is pushed further in the axial direction over the first component such that an inner wall of the second component comes into contact with the adhesive in the radially lower region of the main part, and an adhesive connection is produced between the first and the second component by means of the adhesive.

An actuator for use in a motor vehicle is further claimed, comprising a workpiece as described above, which is manufactured according to the joining method described.

### BRIEF DESCRIPTION OF THE DRAWINGS

An example embodiment of the disclosure, to which the disclosure is not limited, and from which further features according to the disclosure may result, is shown in the following figures. In the figures:

FIG. 1 shows a workpiece in a first assembly state prior to joining,

FIG. 2 shows a workpiece in a second assembly state during joining, and

FIG. 3 shows a workpiece joined together in a final assembly state.

### DETAILED DESCRIPTION

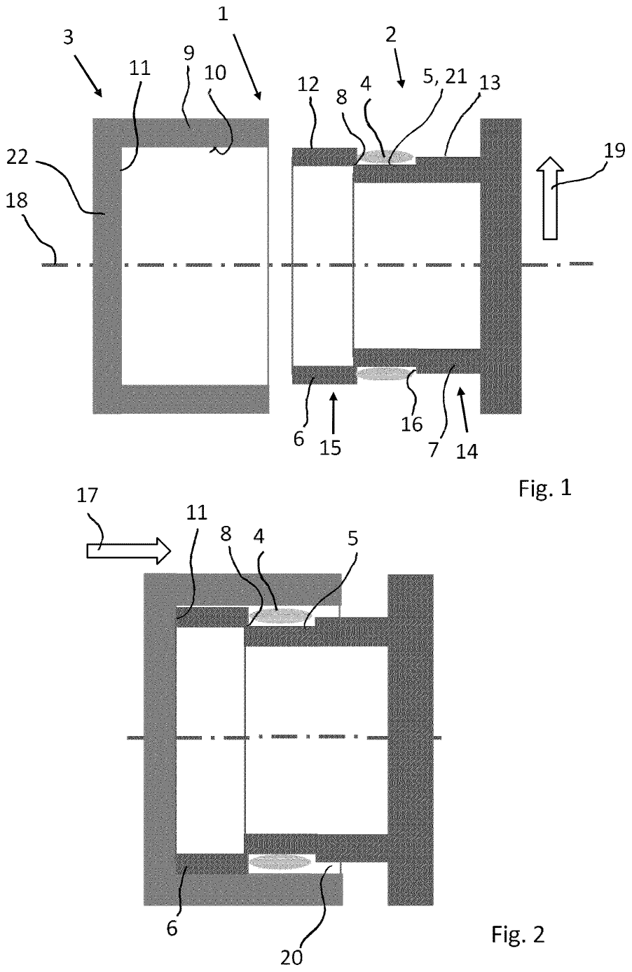

FIG. 1 shows a workpiece 1 with two components 2 and 3. The components 2 and 3 are two hollow cylinders. The first component 2 has an outer diameter on its outer wall 13 that is smaller than the inner diameter of the second component 3 on its inner wall 10. Accordingly, the second component 3 can be pushed onto the first component 2.

The two components 2 and 3 are shown here in a first state. The workpiece 1 is not yet joined together in this first state.

The first component 2 comprises a partial piece 6 and a main part 7. The partial piece 6 is attached axially to the main part 7 via a predetermined breaking point 8 and is essentially ring-shaped. The region of the main part 7 adjacent to the predetermined breaking point 8 extends in the axial direction up to a shoulder 16 on the outer wall 13 of the main part 7. Between the shoulder 16 and the partial piece 6, or the predetermined breaking point 8, the first component 2 forms a circumferential groove 21 as the reservoir 5. The circumferential groove 21 is formed on the outer wall 13 such that the circumferential groove 21 or reservoir 5 is delimited on a radial inner side by the outer wall 13 while being open on a radial outer side.

The reservoir 5 serves as a receptacle for an adhesive 4, which in the first state is filled into the reservoir 5 before the two components 2 and 3 are joined together.

The two components 2 and 3 are designed as hollow cylinders essentially axially symmetrical to an axis 18. The first component 2 has a first radially higher region 15 with the outer wall 12 of the partial piece 6. The term “radially higher” is to be understood here in relation to the radial direction 19 starting from the axis 18. The main part 7 has a second, radially lower region 14 on the outer wall 13, separated from the reservoir 5 by the shoulder 16, which axially delimits the reservoir 5. The amount of adhesive 4 is matched to the depth of the reservoir 5 and the height of the radially higher region 15 in such a way that the adhesive 4 does not radially project beyond the outer wall 12 of the radially higher region 15, which axially delimits the reservoir 5. In other words, the axial width of the reservoir 5 is adapted to the amount of adhesive 4 required to bond the two components 2 and 3 to one another in such a way that the adhesive 4 does not radially project beyond the radially higher region 15. In FIG. 1, the reservoir 5 has a first size or a first volume.

The second component 3, as a hollow cylinder, has an inner wall 10 that projects above the higher region 15 of the first component 2. In the example shown, the second component 3 is pot-shaped with a bottom 22 adjoining a hollow-cylindrical region 9.

Starting from the first state shown in FIG. 1, the second component 3 is pushed onto the first component 2 in a joining method in the joining direction 17, as shown in FIG. 2. In this second state, the inside of the bottom 22 meets the partial piece 6 of the first component as a stop 11. In general, the stop 11 does not have to be the bottom 22; any suitable stop 11 can be provided here. The inner diameter of the hollow-cylindrical region 9 now projects axially and radially beyond the partial piece 6, the reservoir 5 with the adhesive 4, and also the radially lower region 14 of the main part 7 of the first component 2 adjacent to the reservoir 5. As the cylindrical region 9 projects radially beyond the higher region 15, a gap 20 forms between the radially lower region 14 of the first component 2 and the inner wall 10 of the hollow-cylindrical region 9 of the second component 3. As shown in FIG. 2, the reservoir 5 is delimited on a radial outer side by the inner wall 10.

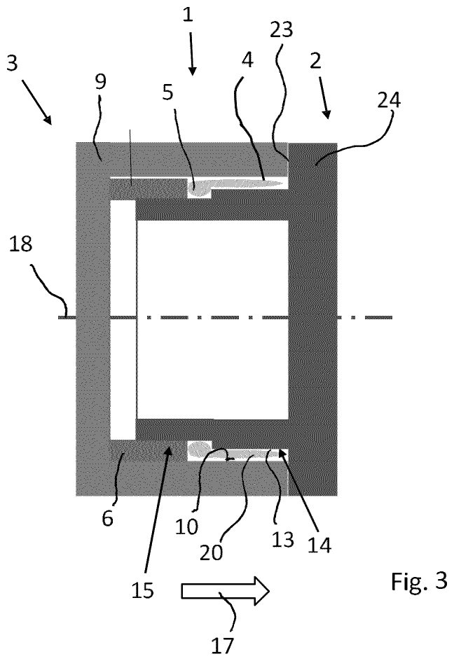

If the second component 3 is pushed further onto the first component 2 in the joining direction 17, the predetermined breaking point 8 will break as a result of the force exerted by the stop 11 on the partial piece 6 in the joining direction 17. As shown in FIG. 3, the partial piece 6 is then moved towards the region of the reservoir 5 due to the force still exerted by the stop 11 and the constraint present in the radial direction due to the inner wall 10. Due to the reducing size or volume of the reservoir 5, adhesive material 4 present there is then displaced into the gap 20 between the hollow-cylindrical region 9 of the second component 3 and the radially lower region 14 of the first component 2. In this joined together state of the workpiece 1 shown in FIG. 3, the first component 2 is bonded to the second component 3 by means of the adhesive 4. In the example shown here, no further axial displacement of the second component 3 in the joining direction 17 can occur due to the axially frontal region 23 of the hollow-cylindrical region 9 meeting a radial section 24 of the first component 2. The two components 2 and 3 are joined together.

In a first alternative version, the partial piece 6 is completely displaced into the reservoir 5. In a further alternative version, the displacement of the partial piece 6 into the reservoir 5 can be terminated by abutting against the shoulder 16. Depending on the length of partial piece 6, only one of the two alternatives can be achieved here. With a shorter partial piece 6, the axial stop 11 would eventually also abut against the main part 7 in the region of the original reservoir 5. A further displacement would not be possible. With a longer partial piece 6, the displacement would be prevented by the partial piece 6 abutting against the shoulder 16. Both alternatives would end in a third state, in which the joining would finally be completed by the first component 2 meeting the second component 3 in the axial direction.

### LIST OF REFERENCE SYMBOLS

1 Workpiece
2 First component
3 Second component
4 Adhesive
5 Reservoir
6 Partial piece
7 Main part
8 Predetermined breaking point
9 Hollow-cylindrical region
10 Inner wall
11 Axial stop
12, 13 Outer wall
14 Radially lower region
15 Radially higher region
16 Shoulder
17 Joining direction
18 Axis
19 Radial direction
20 Gap
21 Groove
22 Bottom
23 Front region
24 Radial section

1. A workpiece comprising two components joined together via an adhesive, wherein a first component of the two components has a reservoir for receiving the adhesive in a first state, and one of the two components undergoes a geometric change in a second state during a joining process such that the reservoir is reduced in size and the adhesive is moved out of the reservoir.

2. The workpiece according to claim 1, wherein the one of the two components comprises a partial piece which in the first state is connected to a main part of the one of the two components via a predetermined breaking point, and the partial piece in the second state is at least partially displaced into a space of the reservoir via a breaking of the predetermined breaking point such that the reservoir is reduced in size.

3. The workpiece according to claim 2, wherein a second component of the two components has a hollow-cylindrical region having an inner wall that at least partially radially encloses the first component of the two components in the second state.

4. The workpiece according to claim 3, wherein the first component of the two components is divided via the predetermined breaking point into an axially frontal region formed by the partial piece and an axially rearward region formed by the main part and the second component has an axial stop which, in the second state, strikes axially against the partial piece during the joining process so as to break the predetermined breaking point and axially displaces the partial piece in a joining direction.

5. The workpiece according to claim 4, wherein the partial piece has an outer wall which lies radially outside of an outer wall of the main part and the adhesive is disposed radially inside of the outer wall in the first state.

6. The workpiece according to claim 4, wherein the first component and the second components are each hollow cylinders which are pushed into one another in the second state.

7. A joining method for joining a first component and a second component in order to form a workpiece according to claim 2, the method comprising:
in a first step, filling a reservoir of the first component with adhesive,
in a second step, pushing the second component onto the first component in a joining direction until an axial stop of the second component strikes against the partial piece of the first component,
in a third step, breaking the partial piece off from the main part of the first component at a predetermined breaking point and pushing the partial piece through the axial stop into the reservoir in the joining direction,
in a fourth step, pressing an adhesive through the partial piece out of the reservoir and into a radially lower region of the main part lying axially behind the reservoir in the joining direction, and
in a fifth step, pushing the second component further in the joining direction over the first component such that an inner wall of the second component contacts the adhesive in the radially lower region of the main part so as to produce an adhesive connection between the first component and the second component via the adhesive.

8. An actuator for a motor vehicle, comprising a workpiece manufactured via the joining method according to claim 7.

9. The joining method according to claim 7, wherein after the fifth step, the partial piece is disposed radially between the first component and the second component.

10. The joining method according to claim 9, wherein when the second component is pushed during the fifth step, the adhesive is displaced outside of the reservoir.

11. The joining method according to claim 7, wherein pushing the second component during the fifth step reduces a volume of the reservoir.

12. A joining method for joining a first component and a second component, the method comprising:
in a first step, filling a reservoir of the first component with adhesive, the reservoir formed as a groove on an outer surface of the first component,
in a second step, pushing the second component onto the first component in a joining direction so that:
an axial stop of the second component strikes against a partial piece of the first component,
the first component is nested within the second component, and
the reservoir is delimited by an inner wall of the second component, and
in a third step, further pushing the second component onto the first component in the joining direction so that the partial piece breaks off of the first component at a predetermined breaking point, and
in a fourth step, further pushing the second component onto the first component in the joining direction so that:
a volume of the reservoir is reduced, and
the adhesive is pressed out of the reservoir and into a radial gap formed between the inner wall of the second component and an outer wall of the first component, and
in a fifth step, further pushing the second component further onto the first component in the joining direction until the second component axially abuts with the first component.

13. The joining method according to claim 12, wherein the first component and the second component are cylindrical in shape.

14. The joining method according to claim 13, wherein the reservoir is an annular groove that extends around the first component.

15. The joining method according to claim 14, wherein in the fourth step, the reservoir is delimited by inner wall of the second component.

16. The joining method according to claim 12, wherein in the fourth step, the adhesive is pressed out of the reservoir via axial displacement of the partial piece.

17. A workpiece assembly comprising:
a first cylindrical component having a reservoir having a first volume is configured for receiving an adhesive,
a second cylindrical component disposed around the first cylindrical component so as to delimit the reservoir, and
a third cylindrical component disposed radially between the first cylindrical component and the second cylindrical component, and
in a first assembly state:
adhesive is disposed in the reservoir, the reservoir open on a radial outer side,
the reservoir is axially delimited by the third cylindrical component and radially delimited by the first cylindrical component on a radial inner side, and
in a second assembly state, the reservoir is radially delimited by the second cylindrical component on a radial outer side, and
in a third assembly state:
the adhesive is disposed in a radial gap via axial displacement of the second cylindrical component and the third cylindrical component, the radial gap formed between the first cylindrical component and the second cylindrical component, and
the reservoir has a second volume less than the first volume.

18. The workpiece assembly of claim 17, wherein in the first assembly state, the third cylindrical component is attached to the first cylindrical component via a predetermined breaking point, and in the third assembly state, the third cylindrical component is broken off of the first cylindrical component.

19. The workpiece assembly of claim 18, wherein in the second assembly state, the first cylindrical component is axially abutted with the third cylindrical component.

20. The workpiece assembly of claim 18, wherein in the third assembly state, the first cylindrical component is axially abutted with the second cylindrical component.
